(19) United States
(12) Patent Application Publication
(10) Pub. No.: US 2006/0056882 A1
(43) Pub. Date: Mar. 16, 2006

(54) Color registration control method and image forming apparatus using the same

(75) Inventors: Gu-dal Kwon, Suwon-si (KR); Eun-ah Song, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/165,677

(22) Filed: Jun. 27, 2005

(30) Foreign Application Priority Data
Sep. 14, 2004 (KR) 10-2004-0073370

(51) Int. Cl. G03G 15/01; B41J 2/385

(52) U.S. Cl. 399/301; 347/116

(57) ABSTRACT

A color registration control method and an image forming apparatus using the same are provided, wherein the color registration control method includes the steps of developing a registration pattern by overlapping a first pattern and a second pattern each of which having a length in a sub-scanning direction, detecting the densities of an upper pattern and a lower pattern included in the registration pattern, comparing the density of the upper pattern with the density of the lower pattern and generating density information, and outputting a registration control signal by referring to the offset information and the density information.

### CROSS-REFERENCE TO RELATED APPLICATIONS

This application claims the benefit under 35 U.S.C. §119(a) of Korean Patent Application No. 10-2004-0073370, filed in the Korean Intellectual Property Office on Sep. 14, 2004, the entire disclosure of which is incorporated herein by reference.

### BACKGROUND OF THE INVENTION

1. Field of the Invention

The present invention relates to a color registration control method and an image forming apparatus using the same. More particularly, the present invention relates to a color registration control method, by which a registration offset is obtained from density information detected in a predetermined color registration pattern by referring to a storage device that stores offset information, and an image forming apparatus using the same.

2. Description of the Related Art

FIG. 1 is a block diagram of a conventional image forming apparatus as disclosed in Korean Patent Publication No. 2001-106148, the entire disclosure of which is incorporated herein by reference. Referring to FIG. 1, the conventional image forming apparatus comprises a central processing unit (CPU) 108 for controlling the entire image forming apparatus, laser scanner units (LSUs) 110 corresponding to four colors, respectively, a photosensitive belt 109, and a plurality of reflection density sensor units 111 for detecting pattern densities at multiple portions on the photosensitive belt 109. Each laser scanner unit 110 comprises a horizontal synchronizing signal detector 112, a pattern generator circuit 103, a clock generator circuit 104, a laser driver 105, an image memory unit 106, and a laser scanner 107. Each reflection density sensor unit 111 comprises a reflection density sensor 100, an amplifier 101, and an analog-to-digital (A/D) converter 102.

FIG. 2 illustrates image patterns generated by the pattern generator circuit 103 shown in FIG. 1 to detect deviation in print position. In FIG. 2, the upper image pattern is a reference color pattern and the lower image pattern is a measured color pattern. Referring to FIG. 2, “W” denotes a line width of an image pattern, “L” denotes an interval in an image pattern, “t” denotes an integer, and “Dmin” denotes a minimum detectable deviation. The reference color pattern has a line width of W and an interval of L in a deviation direction. The measured color pattern overlaps the reference color pattern beginning at a shift of t.Dmin (wherein “t” is an integer) from the reference color pattern in the deviation direction.

The reflection density sensor 100 shown in FIG. 1 radiates light on the reference color pattern and the measured color pattern overlapping the reference color pattern, receives the light reflected from the reference and measured color patterns, and converts the received light into an electrical signal. A minimum density provides a maximum reflectance. Accordingly, the CPU 108 can calculate a deviation between the reference color pattern and the measured color pattern using the quantity of light reflected from an image pattern in which the reference color pattern overlaps the measured color pattern.

However, the conventional technology is disadvantageous in that a large amount of ink and time are needed to detect an image density.

Accordingly, a need exists for a system and method for detecting a registration offset from density information while requiring less ink and time.

### SUMMARY OF THE INVENTION

The present invention provides a color registration control method using an inexpensive density sensor.

The present invention also provides a color registration control method enabling a test pattern to be simplified and optimized, thereby decreasing the amount of ink and operating time needed for registration control.

According to an aspect of the present invention, a registration control method is provided for a color image forming apparatus comprising a storage unit for storing offset information for registration control and a controller for controlling registration, the registration control method comprising the steps of (a) developing a registration pattern by overlapping a first pattern and a second pattern, wherein each of which has a length in a sub-scanning direction, (b) detecting the densities of an upper pattern and a lower pattern comprised in the registration pattern, (c) comparing the density of the upper pattern with the density of the lower pattern and generating density information, and (d) outputting a registration control signal by referring to the offset information and the density information.

The first pattern can comprise upper patterns and lower patterns which alternate with each other in the sub-scanning direction, and each of which is comprised of a plurality of bit lines which each extend in the sub-scanning direction and which are arranged in a scanning direction. The upper patterns can comprise a reference pattern comprised of a plurality of bit lines arranged with a 50% duty and a period of 2 dots, and a sub-pattern comprised of a plurality of bit lines arranged with a 50% duty and a period of 2^{N} times the period of the reference pattern, wherein N is an integer. The lower patterns can comprise the same configuration as the upper patterns.

The second pattern can comprise upper patterns and lower patterns which alternate with each other, and each of which can be comprised of a plurality of bit lines which each extend in the sub-scanning direction and which are arranged in a scanning direction. The upper patterns can comprise a reference pattern comprised of a plurality of bit lines arranged with a 50% duty and a period of 2 dots, and a sub-pattern comprised of a plurality of bit lines arranged with a duty of (½)^{N} times the duty of the reference pattern and a period of 2^{N} times the period of the reference pattern. The lower patterns can comprise patterns shifted by 2^{N} dots from the upper patterns in the scanning direction.

In yet another embodiment of the present invention, the first pattern can comprise a reference pattern comprised of a plurality of bit lines, each of which extends in a scanning direction and which are arranged in the sub-scanning direction with a 50% duty and a period of 2 dots, and a sub-pattern comprised of bit lines which each extend in a scanning direction and which are arranged with a 50% duty and a period of 2^{N} times the period of the reference pattern, wherein N is an integer.

The second pattern can comprise upper patterns and lower patterns which alternate with each other in the sub-scanning direction and each of which is comprised of a plurality of bit lines which each extend in the scanning direction and which are arranged in the sub-scanning direction. The upper patterns can comprise a reference pattern comprised of a plurality of bit lines arranged with a 50% duty and a period of 2 dots, and a sub-pattern comprised of a plurality of bit lines arranged with a duty of (½)^{N} times the duty of the reference pattern and a period of 2^{N} times the period of the reference pattern. The lower patterns can comprise patterns shifted by 2^{N} dots from the upper patterns in the sub-scanning direction.

Step (c) of the method can further comprise the steps of generating a first binary digit when the density of the upper pattern is greater than the density of the lower pattern, and generating a second binary digit when the density of the upper pattern is less than the density of the lower pattern.

Step (d) of the method can further comprise the steps of terminating registration control for a current color when the density information is the same as a basic value of the offset information, and repeating steps (a) through (d) to control registration for another color.

Step (d) of the method can still further comprise the steps of outputting a registration control signal for compensating for a registration offset when the density information is different from a basic value of the offset information, and repeating steps (a) through (d).

Step (d) of the method can still further comprise the steps of outputting one of a laser scanner unit control signal and a belt steering control signal as the registration control signal using the controller.

According to another aspect of the present invention, a color image forming apparatus for color registration control is provided, comprising a density sensor that is positioned above a photosensitive belt to detect a density of an upper pattern and a density of a lower pattern in a registration pattern developed on the photosensitive belt, a comparator for comparing the density of the upper pattern with the density of the lower pattern which are detected in the registration pattern by the density sensor and for generating density information, a storage unit for storing offset information regarding registration offset, and a registration controller for outputting a registration control signal by referring to the offset information stored in the storage unit and the density information received from the comparator, wherein the registration pattern is obtained by overlapping a first pattern and a second pattern which each have a length in a sub-scanning direction.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram of a conventional image forming apparatus;

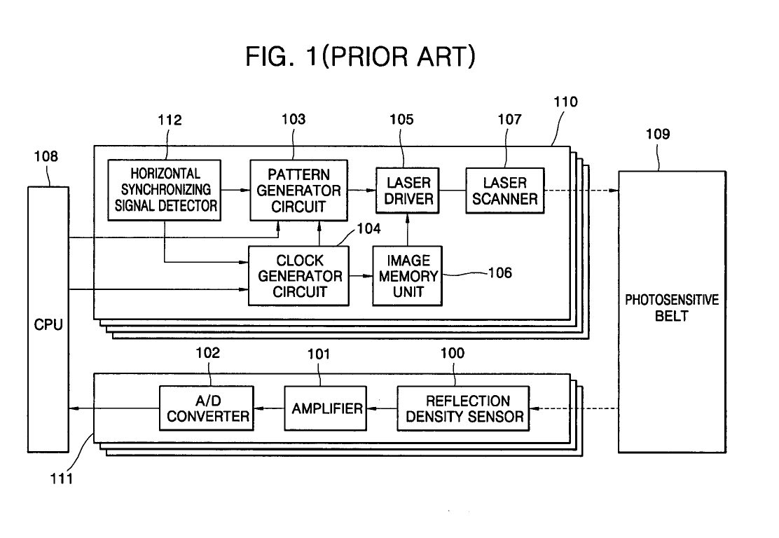

FIG. 2 is a diagram that illustrates a reference color pattern and a measured color pattern which are formed on a photosensitive belt of the image forming apparatus shown in FIG. 1 to detect a deviation in print position;

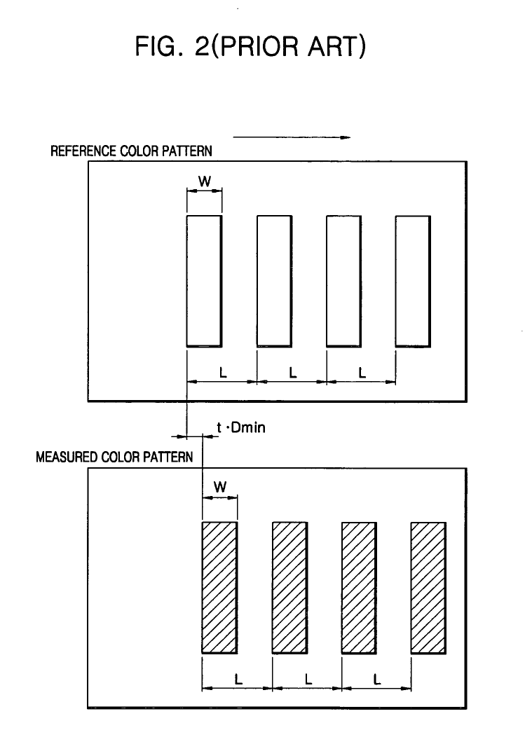

FIG. 3 is a perspective view of an image forming apparatus according to an embodiment of the present invention;

FIG. 4 is a block diagram that illustrates a density sensor and a processing unit according to an embodiment of the present invention;

FIG. 5 is a flowchart of a color registration control method according to an embodiment of the present invention;

FIG. 6 is an image that illustrates a first pattern and a second pattern which are developed on a photosensitive belt of an image forming apparatus to detect an offset in a scanning direction according to an embodiment of the present invention;

FIG. 7 is an image that illustrates examples of a registration pattern in which the first pattern and the second pattern shown in FIG. 6 overlap each other;

FIG. 8 is an image that illustrates a first pattern and a second pattern which are formed to detect an offset in a sub-scanning direction in an image forming apparatus according to an embodiment of the present invention; and

FIG. 9 is an image that illustrates examples of a registration pattern in which the first pattern and the second pattern shown in FIG. 8 overlap each other.

Throughout the drawings, like reference numerals will be understood to refer to like parts, components and structures.

### DETAILED DESCRIPTION OF THE EXEMPLARY EMBODIMENTS

Reference will now be made in detail to embodiments of the present invention, examples of which are illustrated in the accompanying drawings, wherein like reference numerals refer to like elements throughout. Exemplary embodiments are described below in order to explain the present invention by referring to the figures. The present invention may, however, be embodied in many different forms and should not be construed as being limited to the exemplary embodiments set forth herein; rather, these exemplary embodiments are provided so that the disclosure will be thorough and complete, and will fully convey the concept of the present invention to those skilled in the art. Detailed descriptions of functions or structures well know to those skilled in the art are omitted for clarity and conciseness.

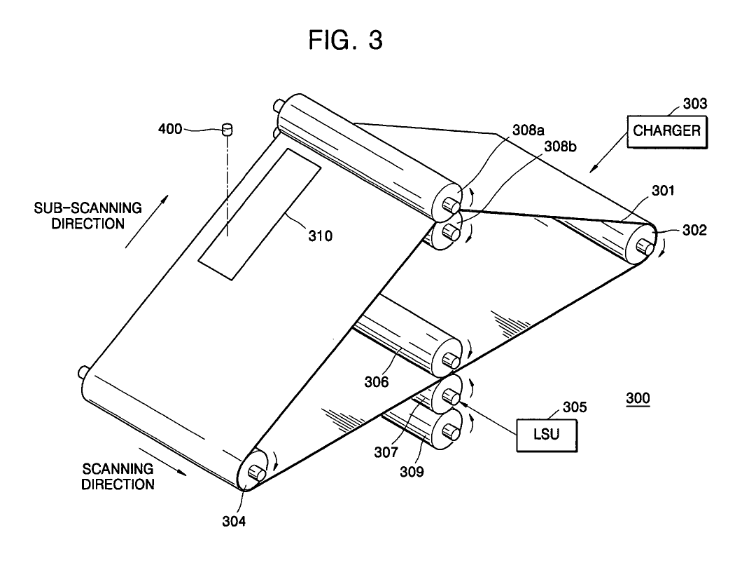

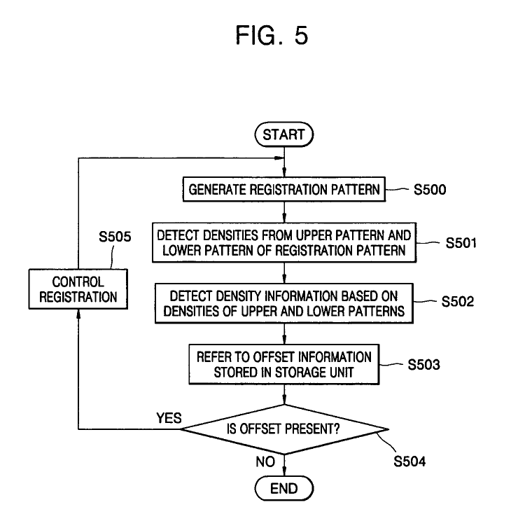

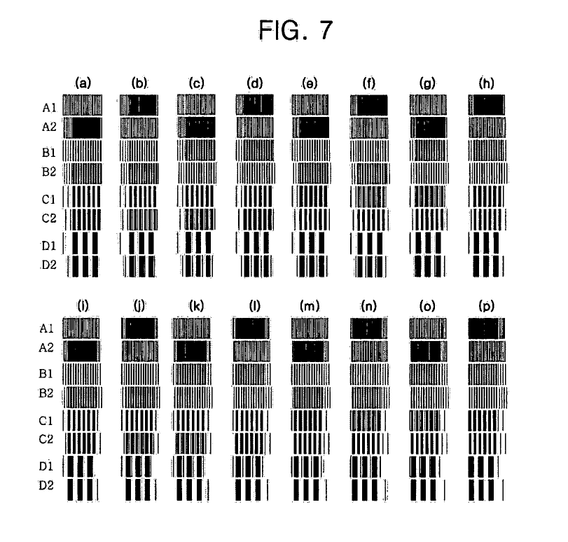

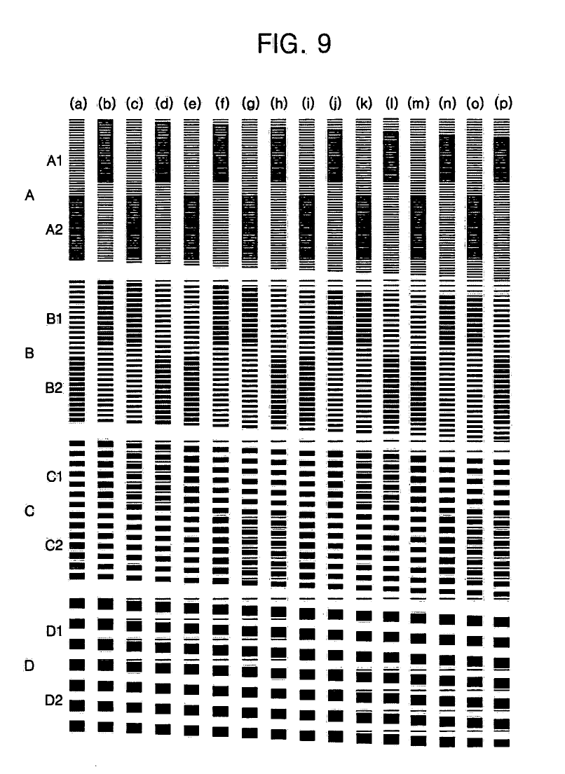

FIG. 3 is a perspective view of an image forming apparatus 300 according to an embodiment of the present invention. The image forming apparatus 300 includes a registration pattern 310 formed on a photosensitive belt 301. The registration pattern 310 is comprised of a plurality of bit lines in a sub-scanning direction or a scanning direction, as shown in FIGS. 7 and 9. The configuration of the registration pattern 310 and a method of detecting an offset of the registration pattern 310 will be described in greater detail below with reference to FIGS. 5 through 9.

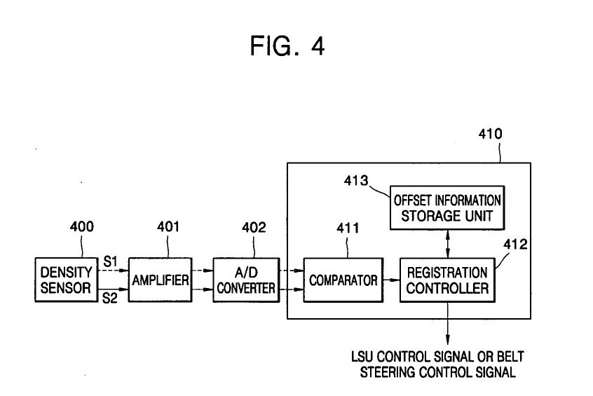

The image forming apparatus 300 radiates light on the registration pattern 310, amplifies and converts the light reflected from the registration pattern 310 from an analog format into a digital format, and detects a density. An exemplary hardware structure of the image forming apparatus 300 including a density sensor 400 is illustrated in FIG. 4.

Referring to FIG. 4, the density sensor 400 radiates light on the registration pattern 310 on the photosensitive belt 301 and transmits density signals S1 and S2 to an amplifier 401. The density signal S1 indicates a density of the upper patterns A1, B1, C1, and D1 (shown in FIG. 7) of the registration pattern 310 for registration control in a scanning direction, or a density of upper patterns A1, B1, C1, and D1 (shown in FIG. 9) for registration control in a sub-scanning direction. The density signal S2 indicates a density of lower patterns A2, B2, C2, and D2 (shown in FIG. 7) of the registration pattern 310 for registration control in the scanning direction, or a density of lower patterns A2, B2, C2, and D2 (shown in FIG. 9) for registration control in the sub-scanning direction.

The density signals S1 and S2 are amplified by the amplifier 401 and are then converted from an analog format into a digital format by an A/D converter 402. The digitized density signals S1 and S2 are then transmitted to a processing unit 410. The density sensor 400, the amplifier 401, and the A/D converter 402 are individually implemented in the hardware structure shown in FIG. 4, however, in yet another embodiment of the present invention the amplifier 401 and the A/D converter 402 can be included within the density sensor 400.

A comparator 411 included in the processing unit 410 compares the digitized density signals S1 and S2, generates a binary digit “0” or “1” according to the result of the comparison, and transmits the generated binary digit to a registration controller 412. The registration controller 412 included in the processing unit 410 outputs a signal for compensating for an offset by referring to an offset information storage unit 413 and the binary digit received from the comparator 411. The signal for compensating for a registration offset may be a signal for controlling a light scanning time of a laser scanner unit (LSU) 305 (shown in FIG. 3), such as an LSU control signal, or a signal for controlling the steering of the photosensitive belt 301, such as a belt steering control signal.

Referring to FIG. 3, the image forming apparatus 300 includes a charger 303, the LSU 305, a developing roller 309, a photosensitive drum 307, a first transfer roller 306, and second transfer rollers 308a and 308b, in addition to the registration pattern 310 and the density sensor 400.

The charger 303 increases a potential of the photosensitive belt 301 to an exposure potential. The LSU 305 radiates light onto the photosensitive drum 307 to decrease a voltage to a developing potential to form an electrostatic latent image. The developing roller 309 delivers a developer with a predetermined color to develop the electrostatic latent image on the photosensitive drum 307. The first transfer roller 306 rotates with the photosensitive drum 307 such that the photosensitive belt 301 passes therebetween and pressurizes the photosensitive belt 301 against the photosensitive drum 307 to transfer the image developed on the photosensitive drum 307 to the photosensitive belt 301. The second transfer rollers 308a and 308b rotate to transfer the image formed on the photosensitive belt 301 to a printing paper (not shown) inserted therebetween.

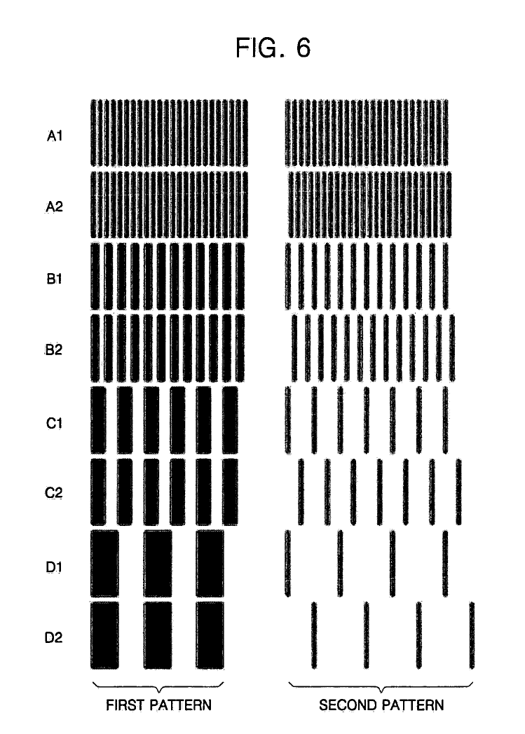

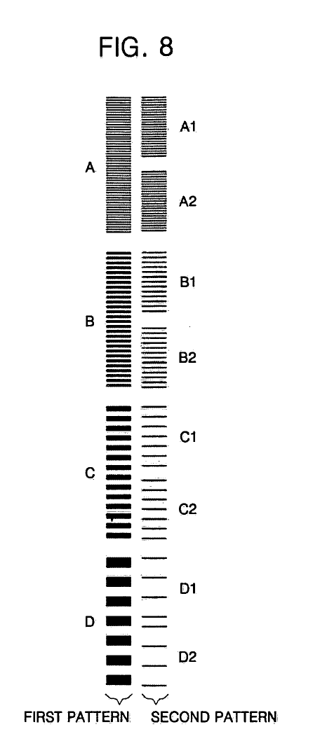

FIG. 5 is a flowchart of a color registration control method according to an embodiment of the present invention. FIG. 6 is an image that illustrates a first pattern and a second pattern which are developed on a photosensitive belt of an image forming apparatus to detect an offset in a scanning direction according to an embodiment of the present invention. FIG. 7 is an image that illustrates examples of a registration pattern in which the first pattern and the second pattern shown in FIG. 6 overlap each other. FIG. 8 is an image that illustrates a first pattern and a second pattern which are formed to detect an offset in a sub-scanning direction in an image forming apparatus according to an embodiment of the present invention. FIG. 9 is an image that illustrates examples of a registration pattern in which the first pattern and the second pattern shown in FIG. 8 overlap each other.

A color registration control method according to an embodiment of the present invention will now be described in greater detail with reference to FIGS. 3 through 9. In step S500, the registration pattern 310 is formed on the photosensitive belt 301 by overlapping the first and second patterns shown in FIGS. 6 and 8. Thereafter, in step S501, densities corresponding to the density signals S1 and S2, are detected from an upper pattern and a lower pattern of the registration pattern 310 using the density sensor 400. In step S502, the comparator 411 compares the densities after being amplified and A/D converted, and generates density information expressed in a binary digit “0” or “1” as the result of the comparison. In step S503, the registration controller 412 refers to the offset information stored in the offset information storage unit 413. Table 1 shows an example of the offset information that can be stored in the offset information storage unit 413.

TABLE 1

| | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| A | 0 | 1 | 0 | 1 | 0 | 1 | 0 | 1 | 0 | 1 | 0 | 1 | 0 | 1 | 0 | 1 |
| B | 0 | 0 | 1 | 1 | 0 | 0 | 1 | 1 | 0 | 0 | 1 | 1 | 0 | 0 | 1 | 1 |
| C | 0 | 0 | 0 | 0 | 1 | 1 | 1 | 1 | 0 | 0 | 0 | 0 | 1 | 1 | 1 | 1 |
| D | 0 | 0 | 0 | 0 | 0 | 0 | 0 | 0 | 1 | 1 | 1 | 1 | 1 | 1 | 1 | 1 |

In Table 1, characters A through D denote parts of a registration pattern 310 as shown in FIGS. 7 and 9, and numerals 0 through 15 on the first row denote offsets expressed in dots, that is, color registration offsets, in the scanning or sub-scanning direction. Binary digits “0” and “1” in the remaining boxes of Table 1 denote density information regarding the registration pattern.

The configurations of the first and second patterns used to form the registration patterns shown in FIGS. 7 and 9 will be described first. Registration in the scanning direction will be described with respect to FIG. 7, and registration in the sub-scanning direction will be described with respect to FIG. 9.

Referring to FIG. 6, each of the first and second patterns include upper patterns A1, B1, C1, and D1, and lower patterns A2, B2, C2, and D2, each of which is comprised of a plurality of bit lines which each extend in the sub-scanning direction and which are arranged in the scanning direction. In FIG. 6, the first pattern is black and the second pattern is red. Usually, cyan, magenta, yellow, and black colors are used in an image forming apparatus. In an embodiment of the present invention, for visually distinct illustration, black and red colors are used.

In the first pattern shown in FIG. 6, the upper patterns A1, B1, C1, and D1, alternate with the lower patterns A2, B2, C2, and D2. The upper pattern A1 is a reference pattern comprised of a plurality of bit lines arranged with a 50% duty and a period of 2 dots. The upper patterns B1, C1, and D1, are sub-patterns comprised of a plurality of bit lines arranged with a 50% duty and a period of 2^{N} times the period of the reference pattern A1 (wherein N is an integer). The lower patterns A2, B2, C2, and D2, have the same configurations as the upper patterns A1, B1, C1, and D1, respectively. For example, the upper pattern A1 is comprised of bits 1010101010101010, the upper pattern B1 is comprised of bits 1100110011001100, the upper pattern C1 is comprised of bits 1111000011110000, and the upper pattern D1 is comprised of bits 1111111100000000. The lower patterns A2, B2, C2, and D2, have the same configurations as the upper patterns A1, B1, C1, and D1, respectively.

In the second pattern shown in FIG. 6, the upper patterns A1, B1, C1, and D1, alternate with the lower patterns A2, B2, C2, and D2. The upper pattern A1 is a reference pattern comprised of a plurality of bit lines arranged with a 50% duty and a period of 2 dots. The upper patterns B1, C1, and D1, are sub-patterns comprised of bit lines arranged with a duty of (½)^{N} times the duty of the reference pattern A1, and have a period of 2^{N} times the period of the reference pattern A1 (wherein N is an integer). The lower patterns A2, B2, C2, and D2, are shifted by 2^{N} dots from the upper patterns A1, B1, C1, and D1, respectively, in the scanning direction. For example, the upper pattern A1 is comprised of bits 1010101010101010, the upper pattern B1 is comprised of bits 1000100010001000, the upper pattern C1 is comprised of bits 1000000010000000, and the upper pattern D1 is comprised of bits 1000000000000000. The lower pattern A2 is comprised of bits 010101010101010101, the lower pattern B2 is comprised of bits 001000100010001000, the lower pattern C2 is comprised of bits 000010000000100000, and the lower pattern D2 is comprised of bits 000000001000000000000000.

The configurations of the first and second patterns for registration control in the sub-scanning direction will now be described in greater detail with reference to FIG. 8.

The first pattern includes a reference pattern A comprised of a plurality of bit lines, each of which extends in the scanning direction and which are arranged in the sub-scanning direction with a 50% duty and a period of 2 dots, and sub-patterns B, C, and D, comprised of bit lines arranged with a 50% duty and a period of 2^{N} times the period of the reference pattern A (wherein N is an integer).

The second pattern includes upper patterns A1, B1, C1, and D1, and lower patterns A2, B2, C2, and D2, each of which is comprised of a plurality of bit lines which each extend in the scanning direction and which are arranged in the sub-scanning direction. The upper patterns A1, B1, C1, and D1, alternate with lower patterns A2, B2, C2, and D2. The upper pattern A1 is a reference pattern comprised of a plurality of bit lines arranged with a 50% duty and a period of 2 dots. The upper patterns B1, C1, and D1, are sub-patterns comprised of bit lines arranged with a duty of (½)^{N} times the duty of the reference pattern A1, and a period of 2^{N} times the period of the reference pattern A1 (wherein N is an integer). The lower patterns A2, B2, C2, and D2, are shifted by 2^{N} dots from the upper patterns A1, B1, C1, and D1, respectively, in the sub-scanning direction.

An example of a method of creating density information like that shown Table 1 will now be described in greater detail with reference to FIG. 7. Densities detected from the upper patterns A1, B1, C1, and D1, of a color registration pattern (a) in FIG. 7 are compared with densities detected from the lower patterns A2, B2, C2, and D2, of the color registration pattern (a). In the example shown, a binary digit “0” is generated as density information if a density of a lower pattern A2, B2, C2, or D2, is greater than that of a corresponding upper pattern A1, B1, C1, or D1. Otherwise, a binary digit “1” is generated as density information. It can be noted that a density of each lower pattern A2, B2, C2, or D2, is never equal to that of a corresponding upper pattern A1, B1, C1, or D1, when the first and second patterns overlap in a color registration pattern as described above. Accordingly, density information of the color registration pattern (a) is expressed as (0, 0, 0, 0). Similarly, density information of color registration patterns (b), (c), (d), (e), (f), (g), (h), (i), (j), (k), (l), (m), (n), (o), and (p), are expressed as (1, 0, 0, 0), (0, 1, 0, 0), (1, 1, 0, 0), (0, 0, 1, 0), (1, 0, 1, 0), (0, 1, 1, 0), (1, 1, 1, 0), (0, 0, 0, 1), (1, 0, 0, 1), (0, 1, 0, 1), (1, 1, 0, 1), (0, 0, 1, 1), (1, 0, 1, 1), (0, 1, 1, 1), and (1, 1, 1, 1), respectively. Therefore, offset information can be plotted on a look-up table (LUT), as show in Table 1. A maximum offset is 15 dots in Table 1 but can be extended to, for example, 32 or 64 dots.

The registration patterns (a) through (p) shown in FIG. 7 can be formed by overlapping the first and second patterns on the photosensitive belt 301 with different offsets. Two adjacent patterns among the registration patterns (a) through (p) have an offset of 1 dot. For example, as compared to the registration pattern (a), red color is shifted by 1 dot from black color in the scanning direction in the registration pattern (b). Similarly, the registration pattern (c) is shifted by 1 dot from the registration pattern (b) in the scanning direction. Accordingly, if a reference value is set to (0, 0, 0, 0) corresponding to the registration pattern (a), registration can be controlled based on the detected density information. For example, when density information detected from a registration pattern developed on the photosensitive belt 301 is (1, 0, 0, 0), that is, the density information of the registration pattern (b) shown in FIG. 7, the processing unit 410 outputs an LSU control signal to shift red color by 1 dot in a direction opposite to the scanning direction, and therefore registration is controlled.

Referring again to FIG. 5, in step S504, the registration controller 412 included in the processing unit 410 determines whether an offset is present by referring to the offset information storage unit 413. If it is determined that an offset is present, the registration controller 412 outputs a control signal to control registration in step S505. The color registration control method is then continued until the offset is substantially 0.

FIG. 9 is an image that illustrates registration patterns (a) through (p) for registration control in the sub-scanning direction. Two adjacent patterns among the registration patterns (a) through (p) have an offset of 1 dot. Accordingly, to compensate for an offset occurring in the sub-scanning direction, the registration controller 412 outputs a belt steering control signal, and therefore, registration is controlled.

As described above, embodiments of the present invention enable color registration to be controlled using an inexpensive density sensor. In addition, as compared to the conventional technology using two or more density sensors, a single density sensor is used which eliminates the need to consider environmental variables. As a result, a look-up table and an algorithm that are used for registration control are also simplified. Moreover, since a test pattern is simplified and optimized, the amount of ink and operating time needed for registration control are reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A registration control method for a color image forming apparatus comprising a storage unit for storing offset information for registration control and a controller for controlling registration, the registration control method comprising the steps of:
(a) developing a registration pattern by overlapping a first pattern and a second pattern, wherein the first and second pattern comprise a length in a sub-scanning direction;
(b) detecting densities of an upper pattern and a lower pattern comprised in the registration pattern;
(c) comparing the density of the upper pattern with the density of the lower pattern and generating density information; and
(d) outputting a registration control signal by referring to the stored offset information and the generated density information.

2. The registration control method of claim 1, wherein the first pattern comprises:
a plurality of upper patterns and lower patterns which alternate with each other in the sub-scanning direction; and
wherein each of the upper patterns and lower patterns is comprised of a plurality of bit lines which each extend in the sub-scanning direction and which are arranged in a scanning direction, and wherein the upper patterns comprise a reference pattern comprised of a plurality of bit lines arranged with a 50% duty and a period of 2 dots, and a sub-pattern comprised of a plurality of bit lines arranged with a 50% duty and period of 2^{N} times the period of the reference pattern, wherein N is an integer, and
wherein the lower patterns have the same configuration as the upper patterns.

3. The registration control method of claim 2, wherein the second pattern comprises:
a plurality of upper patterns and lower patterns which alternate with each other and wherein each of the upper patterns and lower patterns is comprised of a plurality of bit lines which each extend in the sub-scanning direction and which are arranged in a scanning direction; and
wherein the upper patterns comprise a reference pattern comprised of a plurality of bit lines arranged with a 50% duty and a period of 2 dots, and a sub-pattern comprised of a plurality of bit lines arranged with a duty of (½)^{N} times the duty of the reference pattern and a period of 2^{N} times the period of the reference pattern, and
wherein the lower patterns comprise patterns shifted by 2^{N} dots from the upper patterns in the scanning direction.

4. The registration control method of claim 1, wherein the first pattern comprises:
a reference pattern comprised of a plurality of bit lines which each extend in a scanning direction and which are arranged in the sub-scanning direction with a 50% duty and a period of 2 dots; and
a sub-pattern comprised of bit lines which each extend in a scanning direction and which are arranged with a 50% duty and period of 2^{N} times the period of the reference pattern, wherein N is an integer.

5. The registration control method of claim 4, wherein the second pattern comprises:
a plurality of upper patterns and lower patterns which alternate with each other in the sub-scanning direction and wherein each of the upper patterns and lower patterns is comprised of a plurality of bit lines which each extend in the scanning direction and which are arranged in the sub-scanning direction; and
wherein the upper patterns comprise a reference pattern comprised of a plurality of bit lines arranged with a 50% duty and a period of 2 dots, and a sub-pattern comprised of a plurality of bit lines arranged with a duty of (½)^{N} times the duty of the reference pattern and a period of 2^{N} times the period of the reference pattern, and
wherein the lower patterns comprise patterns shifted by 2^{N} dots from the upper patterns in the sub-scanning direction.

6. The registration control method of claim 1, wherein step (c) comprises the steps of:
generating a first binary digit when the density of the upper pattern is greater than the density of the lower pattern; and
generating a second binary digit when the density of the upper pattern is less than the density of the lower pattern.

7. The registration control method of claim 1, wherein step (d) comprises the steps of:
terminating registration control for a current color when the density information is the same as a basic value of the offset information; and
repeating steps (a) through (d) to control registration for another color.

8. The registration control method of claim 1, wherein step (d) comprises the steps of:
outputting a registration control signal for compensating for a registration offset when the density information is different from a basic value of the offset information; and
repeating steps (a) through (d).

9. The registration control method of claim 1, wherein step (d) comprises the step of:
outputting one of a laser scanner unit control signal and a belt steering control signal as the registration control signal using the controller.

10. A color image forming apparatus for registration control, comprising:
a density sensor disposed above a photosensitive belt to detect a density of an upper pattern and a density of a lower pattern in a registration pattern developed on the photosensitive belt;
a comparator for comparing the density of the upper pattern with the density of the lower pattern, wherein the density of the upper pattern and the density of the lower pattern are detected from the registration pattern by the density sensor, and for generating density information;
a storage unit for storing offset information regarding registration offset; and
a registration controller for outputting a registration control signal by referring to the offset information stored in the storage unit and the density information received from the comparator, and wherein the registration pattern is obtained by overlapping a first pattern and a second pattern, and
wherein each of the first pattern and the second pattern comprises a length in a sub-scanning direction.

11. The color image forming apparatus of claim 10, wherein the first pattern comprises:
a plurality of upper patterns and lower patterns which alternate with each other in the sub-scanning direction and wherein each of the upper patterns and lower patterns is comprised of a plurality of bit lines which each extend in the sub-scanning direction and which are arranged in a scanning direction; and
wherein the upper patterns comprise a reference pattern comprised of a plurality of bit lines arranged with a 50% duty and a period of 2 dots, and a sub-pattern comprised of a plurality of bit lines arranged with a 50% duty and a period of 2^{N} times period of the reference pattern, wherein N is an integer, and
wherein the lower patterns have the same configuration as the upper patterns.

12. The color image forming apparatus of claim 11, wherein the second pattern comprises:
a plurality of upper patterns and lower patterns which alternate with each other in the sub-scanning direction and wherein each of the upper patterns and lower patterns is comprised of a plurality of bit lines which each extend in the sub-scanning direction and which are arranged in a scanning direction; and
wherein the upper patterns comprise a reference pattern comprised of a plurality of bit lines arranged with a 50% duty and a period of 2 dots, and a sub-pattern comprised of a plurality of bit lines arranged with a duty of (½)^{N} times the duty of the reference pattern and a period of 2^{N} times the period of the reference pattern, and
wherein the lower patterns comprise patterns shifted by 2^{N} dots from the upper patterns in the scanning direction.

13. The color image forming apparatus of claim 10, wherein the first pattern comprises:
a reference pattern comprised of a plurality of bit lines which each extend in a scanning direction and which are arranged in the sub-scanning direction with a 50% duty and a period of 2 dots; and
a sub-pattern comprised of bit lines which each extend in a scanning direction and which are arranged with a 50% duty and a period of 2^{N} times the period of the reference pattern, wherein N is an integer.

14. The color image forming apparatus of claim 13, wherein the second pattern comprises:
a plurality of upper patterns and lower patterns which alternate with each other in the sub-scanning direction and wherein each of the upper patterns and lower patterns is comprised of a plurality of bit lines which each extend in the scanning direction and which are arranged in the sub-scanning direction; and
wherein the upper patterns comprise a reference pattern comprised of a plurality of bit lines arranged with a 50% duty and a period of 2 dots, and a sub-pattern comprised of a plurality of bit lines arranged with a duty of (½)^{N} times the duty of the reference pattern and a period of 2^{N} times the period of the reference pattern, and
wherein the lower patterns comprise patterns shifted by 2^{N} dots from the upper patterns in the sub-scanning direction.

15. The color image forming apparatus of claim 10, wherein the registration controller is programmable to output one of a laser scanner unit control signal and a belt steering control signal as the registration control signal.

16. The color image forming apparatus of claim 10, wherein the comparator is configured to generate a first binary digit as the density information when the density of the upper pattern is greater than the density of the lower pattern, and generate a second binary digit as the density information when the density of the upper pattern is less than the density of the lower pattern.
